(19) United States
(12) Patent Application Publication
(10) Pub. No.: US 2026/0121849 A1
(43) Pub. Date: Apr. 30, 2026

(54) ACCESS DATA SYNCHRONIZATION SYSTEM AND METHOD

(71) Applicant: Keeper Security, Inc., Chicago, IL (US)

(72) Inventors: Sergey Aldoukhov, Rancho Cordova, CA (US); Craig B. Lurey, El Dorado Hills, CA (US)

(21) Appl. No.: 19/375,671

(22) Filed: Oct. 31, 2025

Related U.S. Application Data
(60) Provisional application No. 63/714,275, filed on Oct. 31, 2024.

(51) Int. Cl. H04L 9/08

(52) U.S. Cl. CPC H04L 9/088

(57) ABSTRACT

A method and system for synchronizing secrets in an enterprise computing network include a secret and a representation of a directed acyclic graph (DAG) generated at a secret client vault device. The representation of the DAG having a plurality of nodes and a plurality of edges, the plurality of nodes including a record node associated with the record, a leaf node associated with a second secret vault client device, and one or more intermediate nodes and the plurality of edges specify a traversal path from the record node to the leaf node. Transmitting a data stream to the second secret vault client device that comprises multiply encrypted data generated in accordance with a traversal of the representation of DAG and representations of the encryption keys associated with the record node and the one or more intermediate nodes of the DAG traversed to generate the multiply encrypted data.

### CROSS-REFERENCE TO RELATED APPLICATION

The present application claims benefit of priority to Aldoukhov et al., U.S. Provisional Patent Application Ser. No. 63/714,275, entitled “Encryption of Zero-Knowledge Password Vault Using Directed Acyclic Graph” and filed Oct. 31, 2024. The entire contents of this application are incorporated herein by reference.

### FIELD OF DISCLOSURE

The present subject matter relates to systems and methods for managing encryption key data and more particularly, systems and methods for managing encryption keys in a distributed cloud environment.

### BACKGROUND

An enterprise may have one or more infrastructure or enterprise devices (e.g., computer systems) that are installed on-premises at a facility associated with the enterprise or that operate on a cloud computing platform such as, e.g., Amazon AWS, Microsoft Azure, etc. Such enterprise devices may be used to manage the operation of the enterprise and store data associated with such operations. End users, e.g., employees, contracted staff, and other authorized users may be provided access to such enterprise devices to monitor and control the operation thereof, access data stored thereon, and the like. Further, IT administrators and development teams may need access to computers of the enterprise used by other end users such as desktop computers, laptop computers, workstations, and the like to support such other end users.

Typically, an end user has to have authentication credentials such as login passwords, SSH keys, database credentials, cloud access keys, and the like associated with infrastructure computer systems and/or resources stored on such computer systems. Further, a group of end users may be grouped as a team and the team may be provided access to certain resources. In addition, resources may be grouped as a folder and a user or a team of users may be provided access to the resources in the folder. Managing the distribution of secure authentication credentials of individual resources or a folder of resources to individual users or a team of users may become challenging as the number of authentication credentials and users increases as the enterprise associated with such credentials scales.

### SUMMARY

According to one aspect, a computer-implemented method for synchronizing secrets in an enterprise computing network includes generating at a first secret vault client device a record comprising a secret and a representation of a directed acyclic graph (DAG) having a plurality of nodes and a plurality of edges. The plurality of nodes includes a record node associated with the record, a leaf node associated with a second secret vault client device, one or more intermediate nodes and the plurality of edges specify a traversal path from the record node to the leaf node. The method further includes specifying a plurality of encryption keys wherein each encryption key is associated with the record node or the one or more intermediate nodes and encrypting the record using an encryption key of the plurality of encryption key associated with the record node to generate encrypted data. The method further includes traversing the one or more intermediate nodes of the representation of the DAG from a node connected to the record node by one of the plurality of edges and, for each intermediate node of the one or more intermediate nodes, encrypting the encrypted data generated by a predecessor node of the intermediate node with an encryption key associated with the intermediate node to generate multiply encrypted data. In addition, the method includes transmitting from the first secret vault client to a secret vault server the representation of the DAG and the multiply encrypted data generated in accordance with the one or more intermediate nodes and generating at the secret vault server. The data stream that comprises the multiply encrypted data generated by the intermediate node connected to the leaf node by one of the plurality of edges, representations of the encryption keys associated with the one or more nodes traversed to generate the multiply encrypted data in accordance with an order of traversal, and a representation of the encryption key associated with the record node. The method further includes transmitting the data stream from the secret vault server to the second secret client vault device.

According to another aspect, a system for synchronizing secrets in an enterprise computing network includes a first secret vault client device, a second secret vault client device, and a secret vault server. The first secret vault client device is configured to generate a record comprising a secret, generate a representation of a directed acyclic graph (DAG) having a plurality of nodes and a plurality of edges. The plurality of nodes includes a record node associated with the record, a leaf node associated with the second secret vault client device, and one or more intermediate nodes. The plurality of edges specify a traversal path from the record node to the leaf node. The first secret vault client device is further configured to specify a plurality of encryption keys wherein each encryption key is associated with the record node or the one or more intermediate nodes and encrypt the record using an encryption key of the plurality of encryption key associated with the record node to generate encrypted data. In addition, the first secret vault client device is configured to traverse the one or more intermediate nodes of the representation of the DAG from a node connected to the record node by one of the plurality of edges and, for each intermediate node of the one or more intermediate nodes, encrypt the encrypted data generated by a predecessor node of the intermediate node with an encryption key associated with the intermediate node to generate multiply encrypted data and transmit to the secret vault server the representation of the DAG and the multiply encrypted data generated in accordance with the one or more intermediate nodes. The secret vault server is configured to generate a data stream that comprises the multiply encrypted data generated by the intermediate node connected to the leaf node by one of the plurality of edges, representations of the encryption keys associated with the one or more intermediate nodes traversed to generate the multiply encrypted data in accordance with an order of traversal, and a representation of the encryption key associated with the record node, and transmit the data stream from the secret vault server to the second secret client vault device.

Other aspects and advantages will become apparent upon consideration of the following detailed description and the attached drawings wherein like numerals designate like structures throughout the specification.

### BRIEF DESCRIPTION OF THE DRAWINGS

FIG. 1 is a schematic diagram of an access data synchronization system in accordance with the present disclosure;

FIG. 2 is an example of a representation of a directed acyclic graph used by the access data synchronization system of FIG. 1;

FIG. 2A is an example of another representation of a directed acyclic graph used by the access data synchronization system of FIG. 1;

FIG. 2B is an example of a further representation of a directed acyclic graph used by the access data synchronization system of FIG. 1;

FIG. 3 is a process flow diagram of steps undertaken by the access data synchronization system of FIG. 1 to modify a representation of a directed acyclic graph;

FIG. 3A is a representation of a directed acyclic graph prior to modification by the access data synchronization system of FIG. 1; and

FIG. 3B is a representation of a directed acyclic graph after modification by the access data synchronization system of FIG. 1.

### DETAILED DESCRIPTION

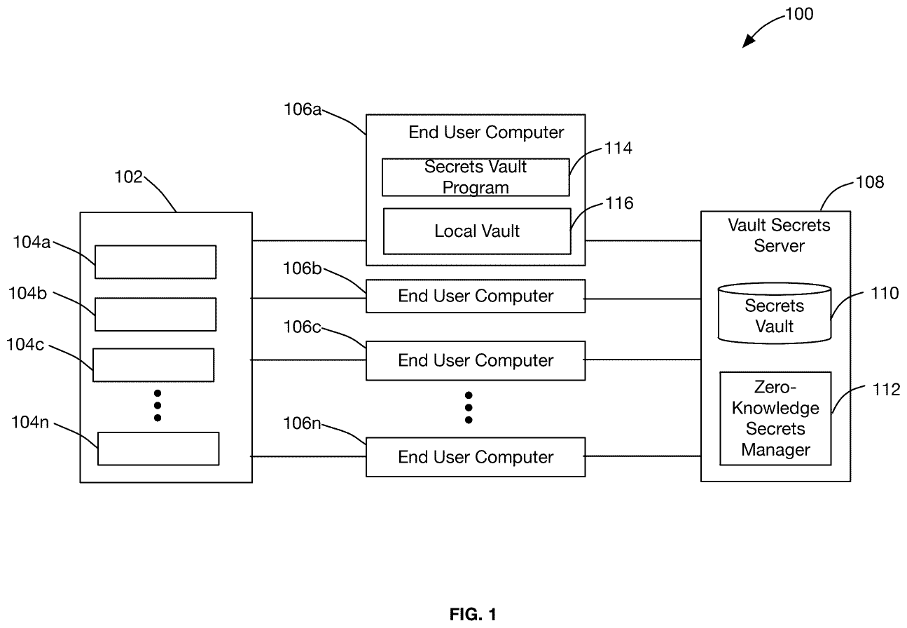

An access data synchronization system (ADS) 100 manages distribution of data necessary to provide one or more end users secure access to encryption-protected resources of a computing environment, such as a zero-knowledge environment. Such resources may include, for example, data files stored in the computing environment, universal record identifiers associated with such data files, authentication credentials (usernames, passwords, SSH keys, etc.), and the like necessary to access devices, data files, and/or programs operating on such devices in the computing environment. Referring to FIG. 1, a computing environment 102 may include computer devices 104a, 104b, 104c, . . . 104n and each such device may have resources such as files, data, and/or application programs stored thereon. Such resources may be accessed by one or more authorized end users using a corresponding end user computer or secret vault client device 106a, 106b, 106c, . . . 106n by providing authentication credentials associated with such resource and the end user. As described in greater detail below, the ADS 100 includes components operating on each end user computer 106 and an access manager device or vault secrets server 108.

In some embodiments, the end-user device 106 may be, for example, a desktop computer, a laptop computer, a mobile computer, and the like operating within an end user network (not shown) or a public network such as the Internet. The computer device 104 having resources accessed by the end user may be a computer operating within the computing environment 102 and the computer environment 102 may be, for example, a local area network, a virtual private network, a network associated with a cloud services provider (e.g., Amazon AWS, Microsoft Azure, etc.), and/or a combination thereof. The one or more computer devices 104 may be, for example, desktop, laptop, and/or mobile computers, server computers, database servers, file servers, and the like installed on premises at a facility associated with an enterprise or may be a computer resource provided by a cloud services provider on behalf of the enterprise. The access manager device 108 may also be a computer and communicates with each end-user device 106 via a public network such as the Internet, a virtual private network, and the like. In some embodiments, the access manager device 108 is installed in a location remote from one or both the computing environment 102 and the end-user device 106. In some embodiments, the access manager device 106 may be on a computer provided by a cloud services provider on behalf of an entity separate from the enterprise.

The vault secrets server 108 may include data stores associated with a secrets vault 110 that is a storage device in which encrypted authentication credentials may be stored. In some embodiments, such encrypted authentication credentials may be encrypted prior to being stored in the secrets vault 110. Further, the access manager device 108 may also store, in the secrets vault 110, access rights associated with a resource or a plurality of resources stored on a computer device 104, an end-user associated with an end user computer 108, and/or a team of end users. The access manager device 108 may include a zero-knowledge secrets manager 112 that facilitates exchange and synchronization of encrypted authentication credentials and access rights information between the vaults secret server 108 and each end user computer 106, via for example, an application programmer interface (API). In some embodiments, the end user computer 106 and the vaults secrets server 108 and the communications and management of secrets therebetween may be implemented in accordance with a zero knowledge system disclosed in Guccione et al., U.S. Pat. No. 12,244,714 (hereinafter Guccione et al.), issued Mar. 4, 2024, and entitled “System and Method for Managing Secrets in Computing Environments,” the entire contents of which are incorporated herein by references. As disclosed in Guccione et al., the authorized end user of an end user computer 106 may encrypt a secret, provide the encrypted secret to the vault secrets server 108, which in turn may provide the encrypted secret to authorized users of other end user computer 106 that are to receive such encrypted secret.

Each end user computer 106 includes a secrets vault program 114 and a local vault 116. As described herein, a first end-user operating a first end-user computer, e.g., end-user computer 106a, may use the secrets vault program 114 and the zero-knowledge secrets manager 112 to create a record that represents a secret, encrypt the record with a record encryption key associated with the record to develop an encrypted record, designate a second end-user that is allowed access to the record, and transmit the encrypted record to a second end user computer 106b associated with the second end-user. In some embodiments, the secret may be, for example, a universal resource identifier associated with a data file stored in the computing environment 102 and/or authentication credentials necessary to access such data file or computer 104 operating in the computing environment 102. In addition, the first end-user may associate the record to a folder and provide the second end-user access to the folder and thereby provide the second end-user access to the record and any other records associated with the folder. Further, the first end-user may associate the first end-user and the second end-user with a team and provide each end-user associated with the team access to an individual record or a folder of records. As described herein, the ADS 100 manages the hierarchical relationships among records, folders, teams, and the like, the end-users who are allowed to access records individually or by association with a folder and/or team, and encryption keys necessary to decrypt data provided to such end-users. Further, the ADS 100 manages changes to such hierarchical relationships and distribution of such changes to end user computers 106 of end users affected by such changes.

In some embodiments, the ADS 100 uses a directed acyclic graph (DAG) to manage the access relationships between records, folders, teams, and end users. In some embodiments, the secrets vault program 114 operating on each end-user computer 106 may have a representation of the DAG associated with records, folders, and teams with the end user authorized to use the end-user computer 106. In addition, the zero-knowledge secrets manager 112 may maintain a system wide representation of the DAGs associated with one or more records, folders, and teams associated with all of the end users authorized to operate the end user computers 106. The zero-knowledge secrets manager 112 may receive a modification to the system wide representation of a DAG from the secrets vault program 114 operating on an end user computer 106 operated by a particular end user. In response, the zero-knowledge secrets manager 112 stores a modified representation of the DAG in the secrets vault 110 and also distribute such modifications to the DAG to the secrets vault program 114 operating on the end user computers 106 associated with other end users affected by such modification. In some embodiments, the representation of the DAG is encoded in accordance with a graph description language such as, for example, DOT that is part of the Graphviz project developed by AT&T Laboratories, Inc. Other graph description languages apparent to one who has ordinary skill in the art may be used in other embodiments.

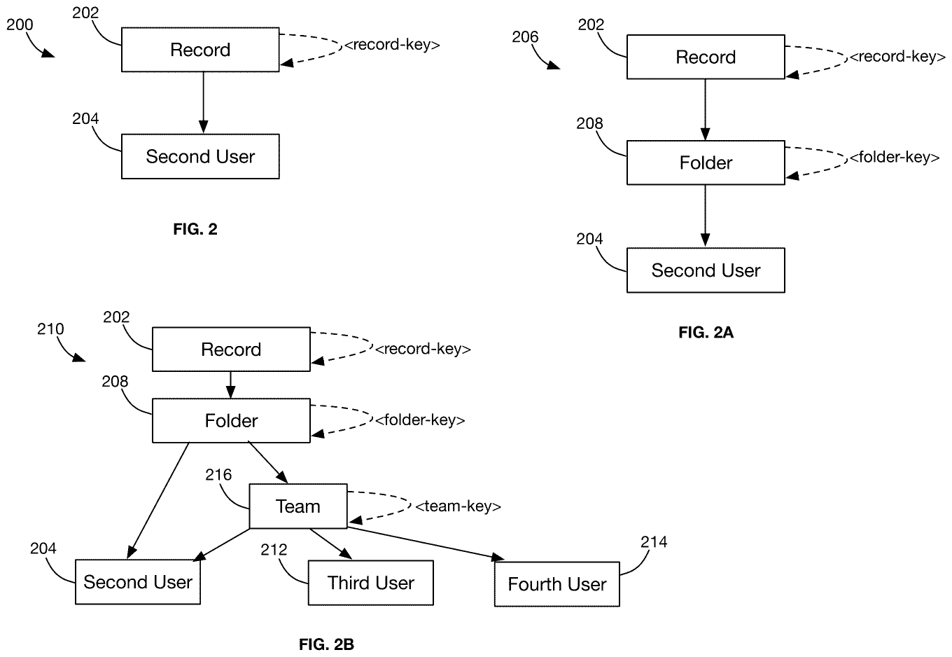

A DAG comprises a plurality of initial (or head) nodes, intermediate nodes, and leaf nodes interconnected by one or more edges. The initial node of the DAG used in the ADS 100 represents a record associated with a secret, the intermediate nodes of the DAG used in the ADS 100 represent data nodes associated with folders, teams, and the like, and the leaf nodes represent end users. In particular, the end user associated with a particular leaf node of the DAG is authorized to access data to a record associated with an intermediate or head node connected to the particular leaf node by one or more edge nodes. FIG. 2 shows a DAG 200 that represents a record assigned by a first end user operating the first end user computer 106a to a second end user operating a second end user computer 106b using the ADS 100. The DAG 200 includes solid edges between nodes that a traversal path through the DAG 200 and dashed lines from a node to itself that indicates that such node is traversed only once. Traversing from the record node 202 to itself comprises encrypting the secret using a record key associated with the record node 202 prior to proceeding to a next node connected thereto. Traversing an intermediate node to itself includes encrypting data generated by an immediately preceding node with an encryption key associated with the intermediate node before proceeding to a next node. In particular, the DAG 200 includes a record node 202 that represents the record connected by an edge to a leaf node that represents the second end user.

The first end user uses the secrets vault program 114 to define the secret represented by the record node 202, store the secret in the secrets vault program 114, designates that the second end user is allowed to access the secret represented by record node 202. In response, the secrets vault program 114 generates and stores the DAG 200 representing such access in secrets vault 114. In addition, the secrets vault program encrypts the secret represented by the record node with a record encryption key (<record-key>) and transmits the encrypted record data, a representation of the record encryption key, and data representing the DAG 200 to the zero-knowledge secrets manager 112. In some embodiments, the secret vault program 114 on the first end user computer 106a encrypts the data representing the DAG 200 using a public key associated with the zero-knowledge secrets manager 112 and transmits the result of such encryption to the zero-knowledge secrets manager 112. In alternate embodiments, the secret vault program 114 on the first end user computer 106a encrypts the DAG 200 and other data transmitted to the secret vault program 114 using the public key of the second end user. In some embodiments, if there are multiple end users authorized to access the record, transmitted data may be sent once for each authorized end user, each time encrypted with the public key associated with such authorized end user. The data transmitted by the secret vault program 114 to the zero-knowledge secrets manager 112 includes identifying information about the second user, a representation of or an identifier of the record encryption key (<record-key>), and the encrypted record data. In some embodiments, the representation of the record encryption key is an identifier associated with an encryption key previously distributed to the one or more end user computer 106 and stored in the local vault 116 on such end user computer 106.

In response, the zero-knowledge secrets manager 112 decrypts the data received from the first end user computer 106a using a private key associated therewith (if necessary) and stores the data representing the DAG 200 and the encrypted record data in the secrets vault 110. As part of the process, the zero-knowledge secrets manager 112 develops a data stream comprising, in order, the representation of encryption key <record-key> used to encrypt the record and the encrypted data representing the data, and encrypts such data stream using a public encryption key associated with the second user and transmits such encrypted data to a second end user computer, e.g., the computer 106b, operated by the second user. The secrets vault program 114 operating on the second end user computer 106b decrypts the received encrypted data stream using a private key associated with the second end user to develop the data stream and stores the data stream in the local vault 116 on the second end user computer 106b. When the second user wishes to access the secret associated with the record represented by the node 202, the secrets vault program 114 retrieves from the local vault 116 the encryption key <record-key> using the identifier of the record encryption key transmitted in the data stream, decrypts the data associated by the node 202 using the retrieved encryption, and provides the resulting decrypted data to the second user.

FIG. 2A shows a DAG 206 that represents an embodiment in which the first end user uses the secret vault program 114 on the first end user computer 106a to associate the secret represented by the record 202 with a folder (represented by the node 208) that may include other records associated with other secrets, and designates that the second end user is authorized to access all of the secrets associated with the folder. In response, the secret vault program 114 operating on the first computer 106a encrypts the data associated with the record using the record encryption key <record-key> to develop record-key-encrypted data and then encrypts the record-key-encrypted data, identifying information associated with the folder, and identifiers of other records associated with the folder and their corresponding record encryption keys with a folder encryption key <folder-key> associated with the folder associated with the node 208 to develop folder-and-record-key encrypted data. As described above in connection with FIG. 2, the folder-and-record-key encrypted data, identifiers associated with the record and folder encryption keys, and data representing the DAG 206 may then be transmitted to the zero-knowledge secrets manager 112 operating on the vault secrets server 108, which stores the received data in the secrets vault 110.

The zero-knowledge secrets manager 112 also develops a data stream that includes the representation of the DAG 206, the identifier of the folder key <folder-key>, the identifier of the record key <record-key>, and folder-and-record-key encrypted data. The zero-knowledge secrets manager 112 encrypts the data stream (or a portion thereof, e.g., an initial element) using the public key associated with the second user and transmits such public key encrypted data to the secrets vault program 114 operating on the second end-user computer 106b. To provide the secret represented by the record node 202 to the second end user, the secrets vault program 114 operating on the second end user computer 106b decrypts the public key encrypted data received from the zero-knowledge secrets manager 112 using the private encryption key associated with the second user to develop the folder-and-record-key encrypted data, retrieves the <folder-key> and the <record-key> from the local vault 116 in accordance with the identifiers in the data stream corresponding to these keys, decrypts the folder-and-record-key encrypted data using the folder key <folder-key> to develop the record-key-encrypted data, and then decrypts the record-key-encrypted data with the <record-key> to develop the secret associated with the record represented in the node 202 and those associated with the folder represented in the node 208. The folder key retrieved from the local vault 116 is a pre-shared key stored in the local vault 116 and associated with the identifier for such key used by the secrets vault program 114 and the zero-knowledge secrets manager 112. In some embodiments, the secrets vault program 114 operating on the second end user computer 106b receives from zero-knowledge secrets manager 112 a data stream encrypted using the public encryption key that has, in order, the an identifier associated with the folder encryption key <folder-key>, an identifier associated with the record encryption key <record-key>, and the folder-and-record-key encrypted data. If multiple folders are involved in the process, multiple folder keys encrypted with the public key of the second user are placed onto the data stream.

FIG. 2C shows a DAG 210 that is created when the first end user uses the secrets vault program 114 operating on the first end user computer 106a to associate the second user represented by the leaf node 204, a third end user represented by the leaf node 212, and a fourth end user represented by the leaf node 214 to a team represented by the node 216 and designates that all of the members of the team have access to the folder represented by the node 208. The secrets vault program 114 encrypts the record data represented by the node 202 with the encryption key <record-key> associated with the record 204 to generate the record-key encrypted data, then encrypts the record-key encrypted data with the encryption key <folder-key> associated with the folder 208 to develop the folder-and-record key encrypted data as discussed above in connection with FIG. 2A and also duplicates and further encrypts the folder-and-record key encrypted data with a team encryption key <team-key> to develop team-folder-and-record-key encrypted data. The secret vault program 114 then stores the folder-and-record key encrypted data, the team-folder-and-record-key encrypted data and the representation of the DAG 210 in the local vault 116. In addition, the secret vault program 114 encrypts, using the public encryption key associated with the zero-knowledge secreta manager 112, identifiers associated with the record key, the folder key, and the team key, the folder-and-record-key encrypted data, the team-folder-and-record-key encrypted data, and the data representing the DAG 210 and transmits the resulting encrypted data to the zero-knowledge secrets manager 112.

In response, the zero-knowledge secrets manager 112 decrypts the encrypted data received from the secret vault program 114 using the private encryption key associated therewith and stores the folder-and-record-key encrypted data, the team-folder-and-record-key encrypted data, and data representing the DAG 210 in the secrets vault 110. Thereafter, the zero-knowledge secrets manager 112 transmits (after encryption using public keys as described above) the identifier associated with the folder encryption key, the identifier associated with the record key, and the folder-and-record-key encrypted data to the second end user computer 106b associated with the second end user. In addition, the zero-knowledge secrets manager transmits to a third end user computer 106c and a fourth end user computer 106d associated with the third and fourth end users a data stream encrypted using the public keys associated with the third and fourth end users, respectively, that comprises, in order, the identifier associated with the team encryption key <team-key>, the identifier associated with the folder encryption key <folder-key>, the identifier associated with the record encryption key <record-key>, and the team-folder-and-record-key encrypted data. The secrets vault programs 114 operating on the third and fourth end user computers 106c, 106d extract the data associated with record by decrypting the received data stream using the private encryption key of the third or fourth end user, respectively, to develop the team-folder-and-record-key encrypted data, retrieving from the local vault 116 the team folder key <team-key>, the folder encryption key <folder-key>, and the record encryption <record-key> in accordance with the identifiers associated with such keys transmitted in the data stream. The secrets vault program then decrypts the team-folder-record-key encrypted data such using the retrieved team encryption key <team-key>, the retrieved folder encryption key <folder-key>, and the retrieved record encryption key <record-key> in order to provide the secret associated with the record to the second or third end user.

It should be apparent to one who has ordinary skill in the art that a record may be assigned to a plurality of folders, and a folder may be assigned to a plurality of teams and/or a plurality of end users, and an end user may be associated with a plurality of teams. In some embodiments, for each particular end user 204, 212, 214 with whom the record associated with the node 202 is shared, the secrets vault program 114 on the first end user computer 106a determines one or more traversal path through the DAG 200, 206, 210 from the node 202 representing the record to each the node 204, 212, 214 and encrypts the data associated with the record using the encryption keys associated with the record node and one or more intermediate nodes (if any) along each traversal path. In some embodiments, the secret vault program 114 on the first end user computer 106 determines a first identified traversal path through the DAG 200 and transmits such path as described in the foregoing. The encrypted data associated with the one or more traversal paths and information regarding the end user(s) associated with such encrypted data are transmitted to the zero-knowledge secrets manager 112. The zero-knowledge secrets manager 112 selects from the encrypted data associated with traversal paths through the DAG 200, 206, 210 between the node 202 that represents the record and the end user 204, 212, 214 and transmits to the end-user computer 106 operated by the end user 204, 212, 214 such selected encrypted data.

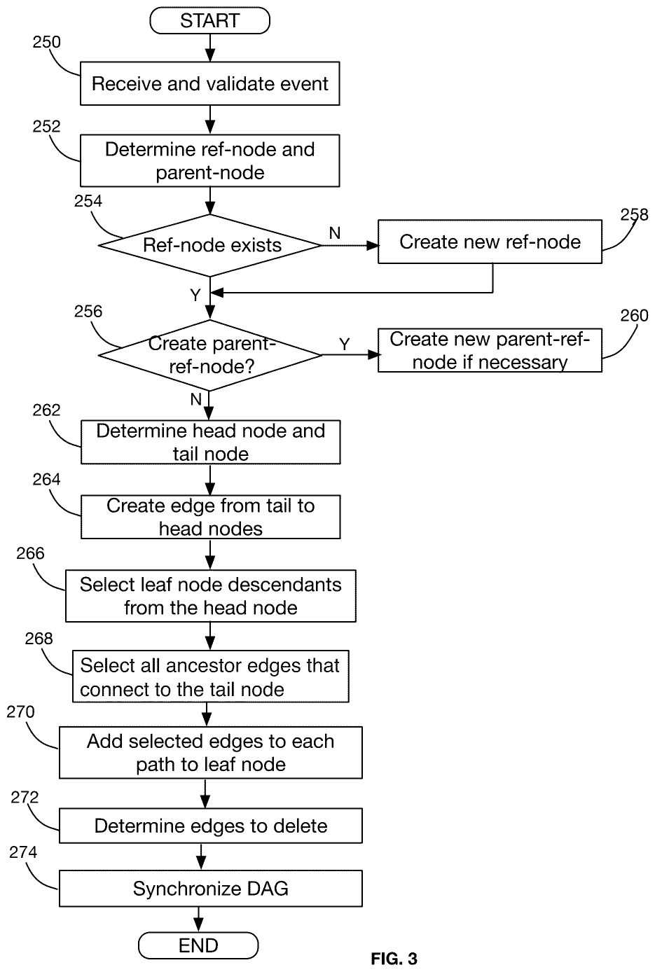

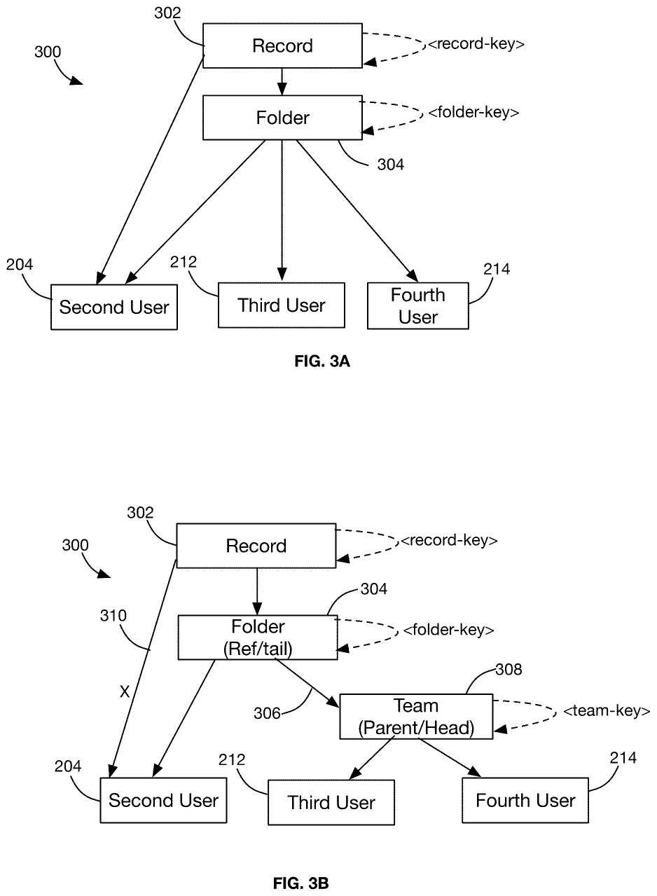

FIG. 3 is a process diagram that illustrates steps undertaken by the secrets vault program 114 (or the zero-knowledge secrets manager 112) in response to receiving an event that represents a modification to a DAG 300 associated with a record. FIGS. 3A and 3B illustrate, respectively, examples of the DAG 300 before a modification in response to receipt of any event and a DAG 300a after receipt of two events that modify the DAG 300. Before receipt of the events, the DAG 300 includes a direct path from a record node 302 to the second end user 204 and a path from the record node 302 to a folder node 304, and paths from the folder node 304 to the third end user 212 and the fourth end users 214. Referring to FIGS. 3, 3A, and 3B, at step 250, the secrets vault program 114 receives data representing the event from an authorized end user of the end user computer 106 and validates the event. Such data may specify a first (reference) node, an optional second node (parent-reference) node, content for the reference node, whether a path between the first and second nodes should be created, updated, or deleted, a flag removing a path from a node to itself. Validating the event data may include, for example, confirming that first and second nodes and paths referenced in the event data exist and that addition, deletion, and updating of paths are logically consistent, and the like.

At step 252, the secrets vault program 114 identifies in the event data a reference node and an optional parent-reference node to which a path from the reference node is to be created. The parent-reference node may be omitted in case a node is to refer to itself (e.g., a path to encrypt data associated with the reference node). In the example shown in FIGS. 3A and 3B, an example event requests an edge 306 be created from the folder node 304 (reference node) to a new team node 308 (parent-reference node) between the node 304 and the nodes 212 and 214. At step 254, the secrets vault program 114 determines if the reference node specified in the event data exists and if so proceeds to step 256. Otherwise, the secrets vault program 114 proceeds to step 258. At step 258, the secrets vault program 114 creates a new node associated with the reference node and proceeds to step 258.

At step 258, the secrets vault program 114 determines if the event data specified a parent-reference node and whether such parent-reference needs to be created (i.e., does not already exist in the DAG). If so, the secrets vault program 114 proceeds to step 260. Otherwise, the secrets vault program 114 proceeds to step 262. At step 260, the secrets vault program 114 creates a new parent-reference node.

At step 262, the secrets vault program 114 associates the reference node to a head node. In addition, the secrets vault program associates the parent-reference node to a tail node if the parent-reference node was specified in the event data, otherwise associates the reference node to the tail node. At step 264, the secrets vault program 114 creates an edge from the tail node to the head node. In the example shown in FIGS. 3A and 3B, the node 304 is associated with the head node, the node 308 is associated with the tail node, and the edge 306 is created therebetween.

At step 266, the secrets vault program 114 selects all leaf nodes (i.e., the nodes 212 and 214 in FIGS. 3B) that descend from the head node (i.e., the node 304 in FIG. 3B). At step 268, the secrets vault program 114 selects all ancestor edges that connect to the tail node (i.e., the edge from node 302 to the node 304). The edges selected at step 268 and the edge created at step 264 comprise a change (or delta) to be projected on the stream corresponding to each leaf node. At step 270, for each leaf node identified at step 266, the secrets vault program 114 identifies the edge(s) of the delta to be projected that is proximate to the leaf node and adds any edges necessary between such identified edge and the leaf node to the DAG 300 (i.e., edges 306, and edges from the node 308 to the nodes 212, 214 are added).

At step 272, the secrets vault program 114 determines if the event data specifies that any edges are to be deleted. If deletion of an edge results in no path from a node to a leaf node, that node may be deleted. In some embodiments, a reference count is developed for each edge from a node (e.g., a record node) to itself that represents a number of paths from such node to a leaf node. For example, if there is an edge from the node directly to the leaf node, a value of a reference count for the edge from the node to itself is set to 1. If the path from the node to the leaf node comprises a path through another node (e.g., a folder node), the value of the reference count of the edge from node to itself is assigned a value of 2. If there is no direct path from the node to the leaf node, the reference count of the edge from the node to itself is decremented by 1. Any node that has an edge to itself that has a reference count of zero is marked for deletion.

At step 274, the secrets vault program 114 operating on the end user computer 106a transmits the representation of modified DAG 300a to the zero-knowledge secrets manager 112, which in turn transmits an update to all of the secrets vault programs 114 on operating on the other end user computer 106b, 106c, . . . , 106n. In some embodiments, the knowledge secrets manager 114, at step 272, transmits information regarding modified edges and nodes of the modified DAG 300a to the secrets vault programs 114, each of which in turn updates the representation of the DAG 300 stored in the local vault 116 to store a representation of the modified DAG 300a therein. In other embodiments, the knowledge secrets manager 114 may transmit the entire representation of the modified DAG 300a to the secret vault programs 114 to replace the DAG stored in the local vault 116 associated therewith.

In some embodiments, the first end user may use the secrets vault program 114 operating on the first end-user computer 106 to modify the DAG as described above even when the first end-user computer 106 is not in communication with the vault secrets server 108 (e.g., if the first end-user computer 106 does not have network access or is offline). In such cases, the secrets vault program 14 undertakes step 274 once communications between the first end user computer 106a and the vault secrets server 108 is available (e.g., after network access is reestablished).

In some embodiments, an edge that is deleted is not deleted from the DAG stored in the secrets vault 110. Instead, an indicator is associated with the deleted edge that instructs the zero-knowledge secrets manager 112 that such edge should not be traversed in the DAG and that such edge should not be distributed when the DAG is synchronized with the end user computers 106.

The access data synchronization system 100 described herein may be used to secure share any type of data represented by a secret encoded in the record node 202. Further, applying multiple levels of encryption prevents unwanted access to the secret. Conventionally, identifiers associated with keys used to apply such multiple levels of encryption and relationships between such levels may have been stored in a relational database. However, in such implementations, determining the relationships and associated encryption keys may require multiple queries to the relational database and also may require duplicating the relational database on each end user computer 106. It should be apparent that using a DAG representation instead of the relational database ameliorates such issues encountered with conventional implementations.

It should be apparent to those who have skill in the art that any combination of hardware and/or software may be used to implement components of the system 100 described herein. It will be understood and appreciated that one or more of the processes, sub-processes, and process steps described in connection with FIGS. 1-4 may be performed by hardware, software, or a combination of hardware and software on one or more electronic or digitally controlled devices. The software may reside in a software memory (not shown) in a suitable electronic processing component or system such as, for example, one or more of the functional systems, controllers, devices, components, modules, or sub-modules depicted in FIGS. 1-4 The software memory may include an ordered listing of executable instructions for implementing logical functions (that is, “logic” that may be implemented in digital form such as digital circuitry or source code, or in analog form such as analog source such as an analog electrical, sound, or video signal). The instructions may be executed within a processing module or controller (e.g., the devices 104, the end user computers 106, the vault secrets server 108, etc.), which includes, for example, one or more microprocessors, general purpose processors, combinations of processors, digital signal processors (DSPs), field programmable gate arrays (FPGAs), application-specific integrated circuits (ASICs), and/or graphics processing units (GPUs). Further, the schematic diagrams describe a logical division of functions having physical (hardware and/or software) implementations that are not limited by architecture or the physical layout of the functions. The example systems described in this application may be implemented in a variety of configurations and operate as hardware/software components in a single hardware/software unit, or in separate hardware/software units.

Depending on certain implementation requirements, the embodiments described can be implemented in hardware and/or in software. The implementation can be performed using a non-transitory storage medium such as a digital storage medium, for example, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according comprise a data carrier having electronically readable control signals, which are capable of cooperating with a processor, a controller, or a programmable computer system, such that one of the methods described herein is performed.

Generally, embodiments disclosed herein can be implemented as a computer program product with a program code, the program code being operative for performing one of the methods when the computer program product runs on a computer. The program code may, for example, be stored on a machine-readable carrier.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. It should be understood that the illustrated embodiments are exemplary only, and should not be taken as limiting the scope of the disclosure.

We claim:

1. A computer-implemented method for synchronizing secrets in an enterprise computing network, comprising:
generating at a first secret vault client device a record comprising a secret;
generating at the first secret vault client device a representation of a directed acyclic graph (DAG) having a plurality of nodes and a plurality of edges, wherein the plurality of nodes includes a record node associated with the record, a leaf node associated with a second secret vault client device, one or more intermediate nodes, wherein the plurality of edges specify a traversal path from the record node to the leaf node;
specifying a plurality of encryption keys, each encryption key being associated with the record node or the one or more intermediate nodes;
encrypting the record using an encryption key of the plurality of encryption key associated with the record node to generate encrypted data;
traversing the one or more intermediate nodes of the representation of the DAG from a node connected to the record node by one of the plurality of edges and, for each intermediate node of the one or more intermediate nodes, encrypting the encrypted data generated by a predecessor node of the intermediate node with an encryption key associated with the intermediate node to generate multiply encrypted data;
transmitting from the first secret vault client to a secret vault server the representation of the DAG and the multiply encrypted data generated in accordance with the one or more intermediate nodes;
generating at the secret vault server a data stream that comprises the multiply encrypted data generated by the intermediate node connected to the leaf node by one of the plurality of edges, representations of the encryption keys associated with the one or more intermediate nodes traversed to generate the multiply encrypted data in accordance with an order of traversal, and a representation of the encryption key associated with the record node;
transmitting the data stream from the secret vault server to the second secret client vault device.

2. The computer-implemented method of claim 1, wherein traversal path comprises a first traversal path and the plurality of edges specify a second traversal path from the record node to the leaf node and the data stream is generated in accordance with a shorter one of the first traversal path and the second traversal path.

3. The computer-implemented method of claim 1, wherein an intermediate node of the one or more intermediate nodes is associated with a collection of a plurality of record nodes.

4. The computer-implement method of claim 1, wherein an intermediate node of the one or more intermediate nodes is associated with a collection of a plurality of secret client vault devices.

5. The computer-implemented method of claim 1, wherein transmitting the data stream to the second secret client vault device comprises encrypting the data stream with a public encryption key associated with the second secret client vault device before transmission.

6. The computer-implemented method of claim 1, wherein transmitting representation of the DAG and the multiply encrypted data to the secret vault server comprises encrypting the representation of the DAG and the multiply encrypted data with a public encryption key associated with the secret vault server.

7. The computer-implemented method of claim 1, further including receiving at the first client device an event that represents a modification to the representation of the DAG, generating a modified representation of the DAG in accordance with the event, and transmitting from the secret vault server to the second client device the modification to the representation of the DAG.

8. The computer-implemented method of claim 7, further including storing the modified representation of the DAG at the first client device while the first client device is not in communication with the secret vault server and transmitting the modification from the first client device to the secret vault server after communication is established.

9. The computer-implemented method of claim 1, wherein the one or more intermediate nodes comprises a first set of intermediate nodes, the leaf node comprises a first leaf node, and the representation of the DAG includes at second set of intermediate nodes between the record node and a second leaf node associated with a third client device, and further including transmitting a portion of the representation of the DAG to the second client device that does not include the second set of intermediate nodes and the second leaf node.

10. A system for synchronizing secrets in an enterprise computing network, comprising:
a first secret vault client device;
a second secret vault client device; and
a secret vault server;
wherein the first secret vault client device is configured to:
generate a record comprising a secret,
generate a representation of a directed acyclic graph (DAG) having a plurality of nodes and a plurality of edges, wherein the plurality of nodes includes a record node associated with the record, a leaf node associated with the second secret vault client device, one or more intermediate nodes, wherein the plurality of edges specify a traversal path from the record node to the leaf node,
specify a plurality of encryption keys, each encryption key being associated with the record node or the one or more intermediate nodes,
encrypt the record using an encryption key of the plurality of encryption key associated with the record node to generate encrypted data,
traverse the one or more intermediate nodes of the representation of the DAG from a node connected to the record node by one of the plurality of edges and, for each intermediate node of the one or more intermediate nodes, encrypting the encrypted data generated by a predecessor node of the intermediate node with an encryption key associated with the intermediate node to generate multiply encrypted data, and
transmit to the secret vault server the representation of the DAG and the multiply encrypted data generated in accordance with the one or more intermediate nodes;
wherein the secret vault server is configured to:
generate a data stream that comprises the multiply encrypted data generated by the intermediate node connected to the leaf node by one of the plurality of edges, representations of the encryption keys associated with the one or more intermediate nodes traversed to generate the multiply encrypted data in accordance with an order of traversal, and a representation of the encryption key associated with the record node, and
transmit the data stream from the secret vault server to the second secret client vault device.

11. The system of claim 10, wherein traversal path comprises a first traversal path and the plurality of edges specify a second traversal path from the record node to the leaf node and the secret vault server is configured to generate the data stream in accordance with a shorter one of the first traversal path and the second traversal path.

12. The system of claim 10, wherein an intermediate node of the one or more intermediate nodes is associated with a collection of a plurality of record nodes.

13. The system of claim 10, wherein an intermediate node of the one or more intermediate nodes is associated with a collection of a plurality of secret client vault devices.

14. The system of claim 10, wherein the secret vault server is configured encrypt the data stream with a public encryption key associated with the second secret client vault device before transmission of the data stream.

15. The system of claim 10, wherein the first secret vault client is configured to encrypt the representation of the DAG and the multiply encrypted data with a public encryption key associated with the secret vault server before transmission thereof.

16. The system of claim 10, the first secret vault client device is configured to receive an event that represents a modification to the representation of the DAG, generate a modified representation of the DAG in accordance with the event and the secret vault server is configured to transmit to the second client device the modification to the representation of the DAG.

17. The system of claim 16, wherein the first secret vault client is configured to store the modified representation of the DAG at the first client device while the first client device is not in communication with the secret vault server and transmit the modification from the first client device to the secret vault server after communication is established.

18. The system of claim 10, wherein the one or more intermediate nodes comprises a first set of intermediate nodes, the leaf node comprises a first leaf node, and the representation of the DAG includes at second set of intermediate nodes between the record node and a second leaf node associated with a third client device, and the secret vault client is configured to transmit a portion of the representation of the DAG to the second client device that does not include the second set of intermediate nodes and the second leaf node.
